(19) United States
(12) Patent Application Publication
(10) Pub. No.: US 2006/0075069 A1
(43) Pub. Date: Apr. 6, 2006

(54) Method and system to provide message communication between different application clients running on a desktop

(76) Inventors: Prabhuram Mohan, San Jose, CA (US); Chathnaur Venkatesh, San Jose, CA (US); Krishnakumar Pandurangan, San Jose, CA (US)

Correspondence Address: SCHWEGMAN, LUNDBERG, WOESSNER & KLUTH, 1600 TCF TOWER, 121 SOUTH EIGHT STREET, MINNEAPOLIS, MN, 55402, US

(21) Appl. No.: 10/950,239

(22) Filed: Sep. 24, 2004

(51) Int. Cl. G06F 15/16

(52) U.S. Cl. 709/218

(57) ABSTRACT

A method and system to facilitate the communication of data and/or messages between a browser-based application and a non browser-based application including, at the browser-based application, embedding data in an anchor portion of a URL string and invoking execution of an embedded browser component of the non browser-based application by communicating the URL string to the second application. At the non browser-based application, the received URL string is parsed and the relevant data extracted therefrom.

### RELATED APPLICATION

The present application is related to, incorporates by reference and hereby claims the priority benefit of the following U.S. Patent Application:

U.S. Provisional patent application Ser. No. 10/660,418, filed Sep. 10, 2003, entitled “Method and System to provide Message Communication between Different Browser Based Applications running on a Desktop”.

### FIELD OF THE INVENTION

An embodiment of present invention relates generally to the field of data communications and, and in one embodiment, to the communication of data between the network-based applications clients.

### BACKGROUND OF THE INVENTION

Many modern applications are browser-based so as to render these applications portable, and to provide the advantage of zero-install requirements on a computer system. However, current browsers ((e.g., the Internet Explorer (IE) browser developed by Microsoft Corporation of Redmond, Wash. State, and the Mozilla browser developed by the Mozilla Organization) implement policies that prevent a browser-based application from communicating with a non browser-based application, even though both applications are executing on the same computer system.

One option to enable such communication is to customize the applications with a common interface. The other option is to use special controls, such as Active X Control and Active Document Interface. These controls enable the browser-based application to send message content to a non browser-based application and a non browser-based application to receive the message content. However, these controls need to be maintained and are often specific to a product. For example, Active X Control is used for Internet Explorer.

FIG. 1 is a block diagram illustrating a first client machine 10 that hosts a browser-based application 12 and a non-browser based application 14. The browser-based application 12 includes a browser and sending control. Similarly, the non browser-based application 14 supports a user interface and receiving control.

The first client machine 10 is connected to other network systems via the network 20 (e.g., Internet or Local Area Network). The other network systems include application server 15, second client machine 17 (e.g., mobile device, PDA) and third party application server 19.

The application server 15 and second client machine 17 communicate with the first client machine 10 via the browser-based application 12. The third-party application server 19 communicates with the first client machine 10 via the non browser-based application 14.

FIG. 2 is an interaction flow chart illustrating the communication between the browser-based application 12 and the non browser-based application 14. As illustrated in FIG. 2, following the identification of message content at block 22, the browser-based application 12 at block 24 activates a sending control prior to communicating the message content to the non browser-based application 14 at block 26.

At block 28, the non browser-based application 14 invokes a receiving control, therefore, enabling the non browser-based application 14 to receive the message content from the browser-based application 12 at block 30. The non browser-based application 14 communicates the message content to the third party application server 19 at block 32.

At block 34, the third party application server 19 receives the message content, and possibly performs a function utilizing this message content. At block 36, the third party application server 19 communicates a result of the function to the non browser-based application 14. The non browser-based application 14 may display the result of the function, for example as a screen pop at block 38.

### SUMMARY OF THE INVENTION

According to one aspect of the present invention, there is provided a method to communicate data between a browser-based application and a non-browser-based application. The method includes the first application client invoking execution of an embedded browser component of the second application client by communicating the URL string to the second application client; and at the second application client, parsing the URL string and extracting the data therefrom, wherein the parsing of the URL string at the second application client causes the second application client to perform a function using the data.

According to a further aspect of the present invention, there is provided a method to facilitate the communication of data between browser-based application and a first non-browser application, utilizing a second non browser-based application to bridge the communication protocol of the browser-based application and the first non-browser application.

Other features of the present invention will be apparent from the accompanying drawings and from the detailed description that follows.

### BRIEF DESCRIPTION OF THE DRAWINGS

The present invention is illustrated by way of example and not limitation in the figures of the accompanying drawings, in which like references indicate similar elements and in which:

FIG. 1 is a block diagram illustrating a prior art scenario of communication between a browser-based application and a non browser-based application;

FIG. 2 is an interaction flow chart illustrating communication between a browser-based application and a non browser-based application in the prior art;

FIG. 3 is a diagrammatic representation of the structure of an exemplary URL;

FIG. 4 is a diagrammatic representation of a markup language document that is shown to include a hypertext link that in turn includes an anchor portion;

FIG. 5 is a block diagram illustrating a system, according to an exemplary embodiment of the present invention, to communicate data between a browser-based application and a non browser-based application;

FIG. 6 is an interaction flow chart illustrating a method, according to one exemplary embodiment of the present invention, to communicate data between a browser-based application and a non browser-based application;

FIG. 7 is a block diagram illustrating a system, according to an alternative embodiment of the present invention, to communicate data between a browser-based application and a non browser-based application;

FIG. 8 is a flow chart illustrating a method, according to an alternative embodiment of the present invention, to facilitate the communication of data between a browser-based application and a non browser-based application; and

FIG. 9 is a block diagram illustrating a machine, in the exemplary form of a computer system, which stores a set of instructions for causing the machine to perform any of the methodologies discussed herein.

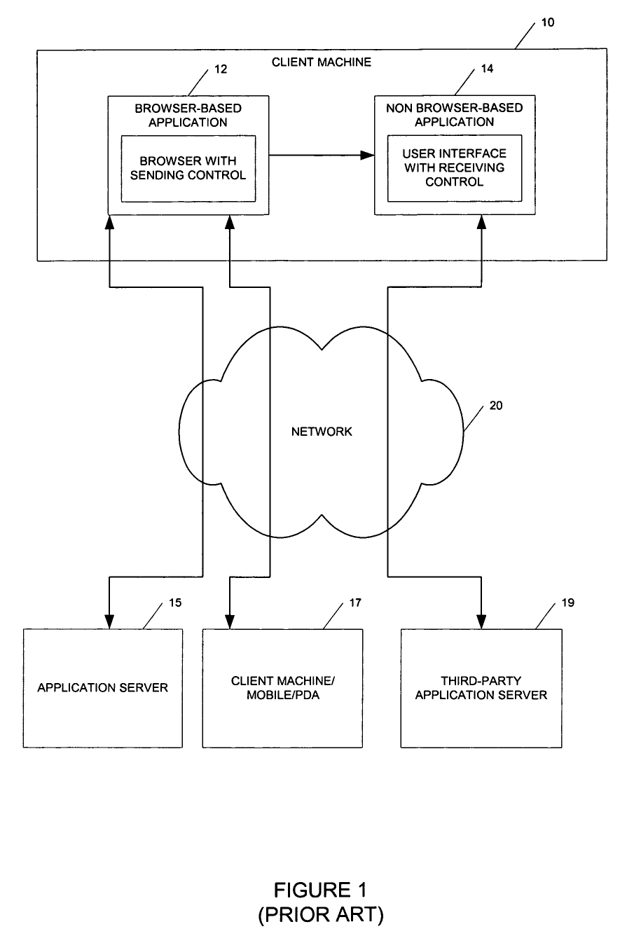

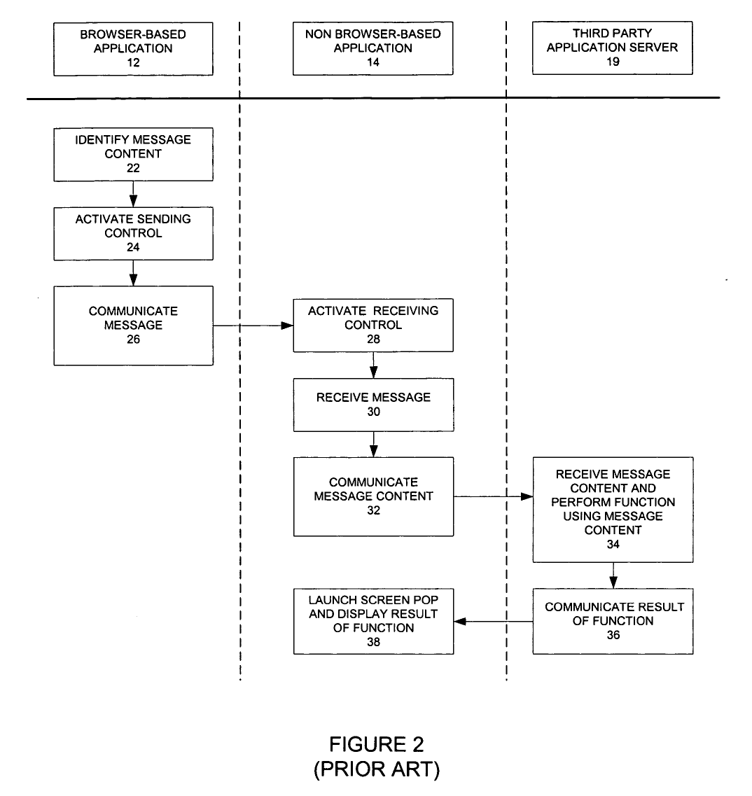

### DETAILED DESCRIPTION

A method and a system to communicate data between a browser-based application and a non browser-based application are described. In the following description, for purposes of explanation, numerous specific details are set forth in order to provide a thorough understanding of the present invention. It will be evident, however, to one skilled in the art that the present invention may be practiced without these specific details.

One embodiment relates to a method to enable the communication of data between a browser-based application and a non browser-based application, without requiring special controls to be implemented at the applications. An understanding of one exemplary embodiment of the present invention will be assisted by a brief description of the syntax of Uniform Resource Locators (URLs), and the manner in which browser applications utilize such URLs.

A browser application will typically reload data (e.g., a web page) when the browser application receives a URL that includes different parameters. For example, a browser application may receive a URL as a result of a user typing the URL into an input line. Alternatively, a browser application may receive a URL as a result of user “clicking” on a hypertext link that is included in a web page being displayed. A browser application can also receive a URL from a number of other sources including from another instance of a particular browser application that is executing on a machine. For example, where a particular browser instance receives the URL “http://www.domainA.com/a.html”, the browser application will load a page identified by that URL from an appropriate server at the domain “domainA.” If the same browser instance then subsequently receives a further URL “http://www.domainA.com/a.html?a=21”, the browser application will reload a page by making a request to the appropriate server, this request involving a passing of the parameter “a=21”. In short, when a browser instance receives a URL that is different from the URL that it most recently received, the browser instance will typically issue a request to an appropriate server, identified by the URL. Further, unless special properties are set for the page, the browser will be forced to perform the load even if the URL is the same.

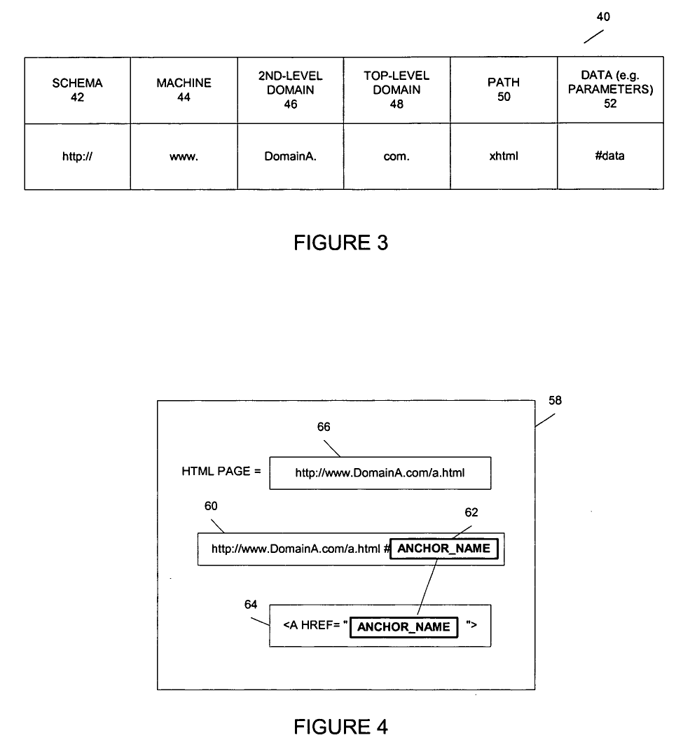

FIG. 3 is a diagrammatic representation of the syntax of an exemplary URL 40. The URL 40 includes a number of portions, namely a scheme portion 42 that identifies a scheme (e.g., http, gopher, ftp, news, etc.) for the URL 40, a machine portion 44 that identifies the type of machine to which the URL 40 is directed (e.g., a World Wide Web (www) machine), a second-level domain portion 46 that indicates a second-level domain to which the URL 40 is addressed, a top level domain portion 48 that indicates a top level domain (e.g., an organization or a country), a path portion 50 that typically indicates a path at the identified domain, and possibly a data portion 52 that may include data (e.g., a message, parameter, value, etc.) to be communicated to the identified domain.

For the purposes of the present specification, any of the above portions 42-52 may be regarded as identifying a domain.

Browser applications also typically support a so-called “linking” feature, which will move a page being displayed by a browser instance to a specific position on the page. This linking feature is typically implemented utilizing so-called “anchors”. An “anchor” may be regarded, in one exemplary embodiment, as a location in a document or data set that is the target of a hypertext link.

FIG. 4 is a diagrammatic representation of a markup language document 58 (e.g., an HTML document) that is shown to include hypertext link 60, which in turn includes an anchor portion 62. As illustrated, the anchor portion 62 is denoted by the inclusion of a hash symbol (#) within the URL string that comprises the link 60. Specifically, text after the hash symbol constitutes a “name” attribute can be used to link to an anchor location 64 within the same document. Such an anchor location 64 is shown to be included within the markup language document 58, and identifies the anchor “name”. Accordingly, a user, by clicking on the link 60, will cause a display of the markup language document 58 to be adjusted by the browser instance so the anchor location 64 within the document 58 is brought into view of the user. For example, the document 58 might be scrolled by the browser instance to bring the anchor location 64 into the display window of the browser instance.

It should be noted that when a user selects a hypertext link, such as the link 60, that identifies an anchor (e.g., has an anchor portion 62), the relevant browser instance does not reload the document (e.g., a markup language document 58) from the server identified if the “anchor” is part of the URL identifying a document currently being displayed by the browser instance. For example, with reference to FIG. 4, consider that the document 58 currently being displayed by the browser instance is identified by the URL 66. It will be noted that the URL for the link 60 corresponds exactly to the URL 66, except that the anchor portion 62 is appended thereto. Accordingly, when a user selects the link 60, the URL 66 for the current page is identified as corresponding to the URL for the link 60 except for the anchor portion 62. Accordingly, the browser instance will not reload the document 58, identified by the URL for the link 60 from a server, but will simply scroll the display of the document 58 to bring the anchor location 64 into view.

Should a browser instance attempt to jump to an anchor identified by link 60 in an already loaded document, and the relevant anchor is not located, the browser instance does not take any further action. However, when the browser instance does attempt to locate the anchor, the URL that is registered by the browser instance is changed to the URL for the most recently selected “anchor-referencing” link 60. Accordingly, should a user select the link 60, the URL registered by the browser instance for the displayed document 58 would be changed to the URL that is illustrated in FIG. 4 as being associated with the link 60. In short, input of a URL string to a browser instance that identifies an anchor within the same document, regardless of whether the identified anchor actually exists or not, will cause the URL string registered by the browser instance to change.

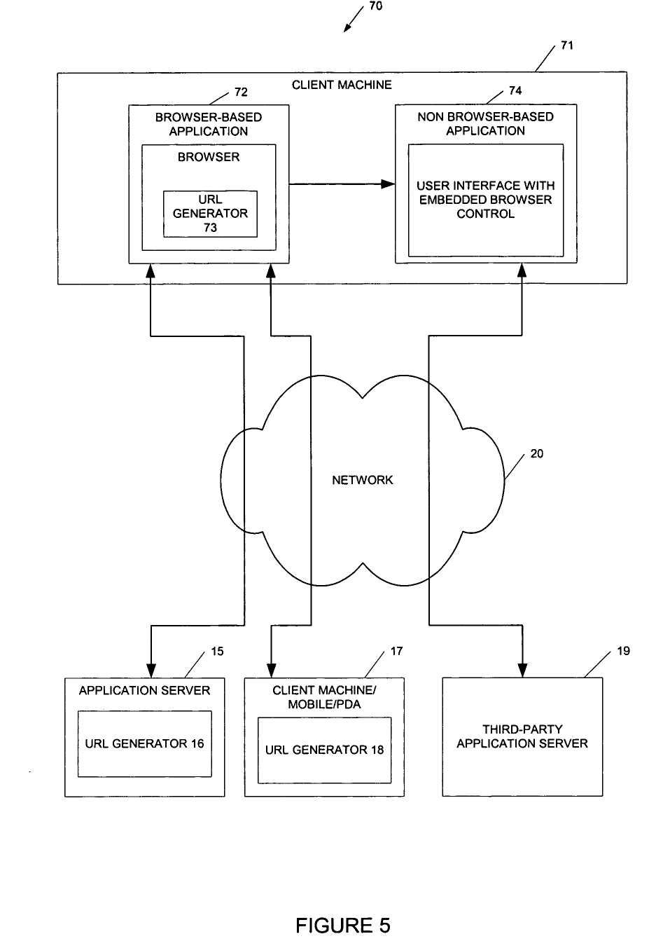

According to one embodiment of the invention, this above-described “anchor” functionality is utilized to pass data (e.g., messages) between browser-based application and non browser-based application, and without necessarily invoking a server-side access operation. Further details will now be described with reference to FIGS. 5-8.

FIG. 5 is a block diagram illustrating a network environment 70, in which one exemplary embodiment of the present invention is shown to be implemented. Specifically, a first client machine 71 hosts a browser-based application 72 and a non browser-based application 74. The browser-based application 72, which in the exemplary embodiment of the present invention presents a display window in the form of a browser to the user, operates as a receiver client. In one embodiment, the browser-based application 72 may also include a URL generator 73 to enable the generation of URL strings. The URL generator 73 may, for example, be a script or an applet that is invoked by HTML communicated to the browser-based application 72 from the application server 15. In addition, the URL generator 73 allows the browser-based application 72 to attach a message content in the anchor portion 62 of a URL string.

The non browser-based application 74 includes a browser control, which opens a window within the application. In the exemplary embodiment of the present invention, another application, such as the browser-based application 72, may invoke the browser control of the non browser-based application 74.

The first application server 15 includes a URL generator 16 that operates to generate ULR strings that may be utilized to communicate message content to the browser-based application 72. Similarly, the second client 17 may also include a URL generator 18.

In any event, it will be appreciated that, in various embodiments of the present invention, URL strings that are useful for implementing the present invention may be generated at either the client side, server side, or at both the client and the server side.

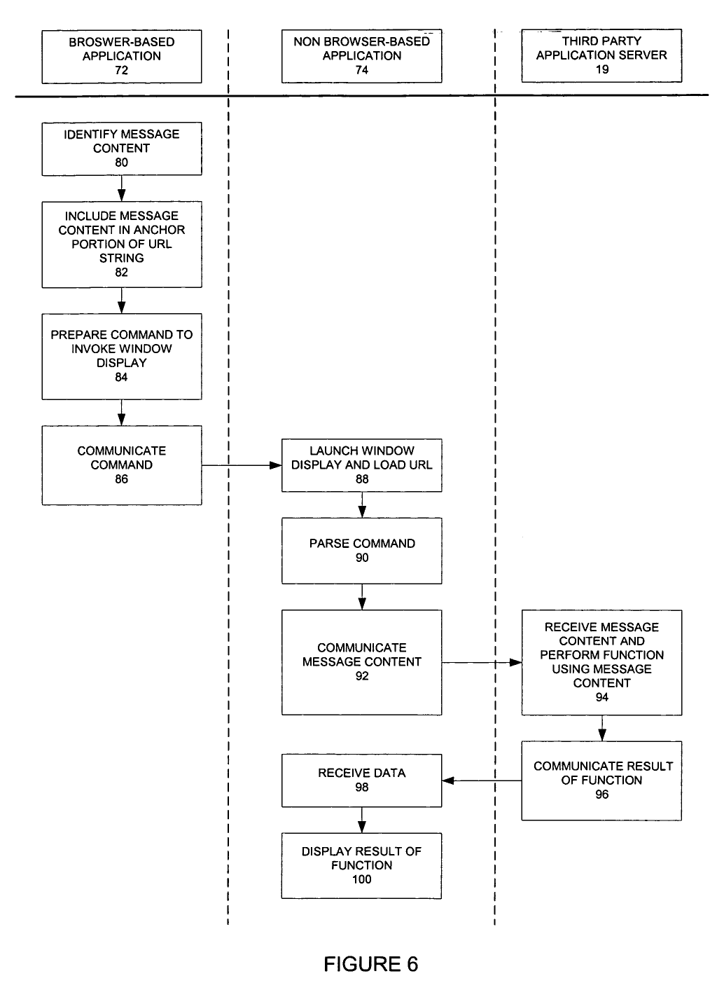

FIG. 6 is an interaction flow chart illustrating a method, according to an exemplary embodiment of the present invention, to communicate message content between browser-based and non browser-based applications in the network environment 70 as described above in FIG. 5.

Starting at block 80, the browser-based application 72 identifies a message content which, in one exemplary embodiment, requires the third party application server 19 to perform some functions. At block 82, the browser-based application attaches the message content in an anchor portion 62 of a URL string that is addressed to the third party application server 19 to be executed within the non browser-based application 74. An example of a URL string that may be generated at block 82 is: “http://www.server19.com/receiver.html#message”.

In this exemplary URL, the data that is included in the anchor portion 62 is the text “message”. It will be appreciated that the data that is included in the URL string could be any data type, including alphanumeric, graphic, audio or video data. The above exemplary URL string is also addressed to the third party application server 19, and also calls a HTML document, namely, “receiver.html”.

At block 84, the browser-based application 72 prepares the command to invoke the embedded browser control of the non browser-based application 74. An example of such a command is “window.open”, as implemented by Microsoft Corporation of Redmond, Wash. State. In this embodiment, the command that is generated in block 84 is: “window.open(“http://www.server19.com/receiver.html#message, “name of embedded browser”).

The command is communicated to the non browser-based application 74 at block 86, which invokes the embedded browser control to open a display window and launches the specified URL at block 88. In this example, the display window may be a browser. At block 90, the non browser-based application 74 parses the received URL string to extract the message content contained in the anchor portion 62 thereof. Thereafter, at block 92, the non browser-based application 74 communicates the message content to the third party application server 19.

At block 94, the third party application server 19 receives the extracted data, and may optionally perform one or more functions utilizing this data. The result of the function is returned to the non browser-based application 74 in block 96.

The non-browser based application 74 receives the result at block 98. The result is displayed in the window of the non browser-based application 74.

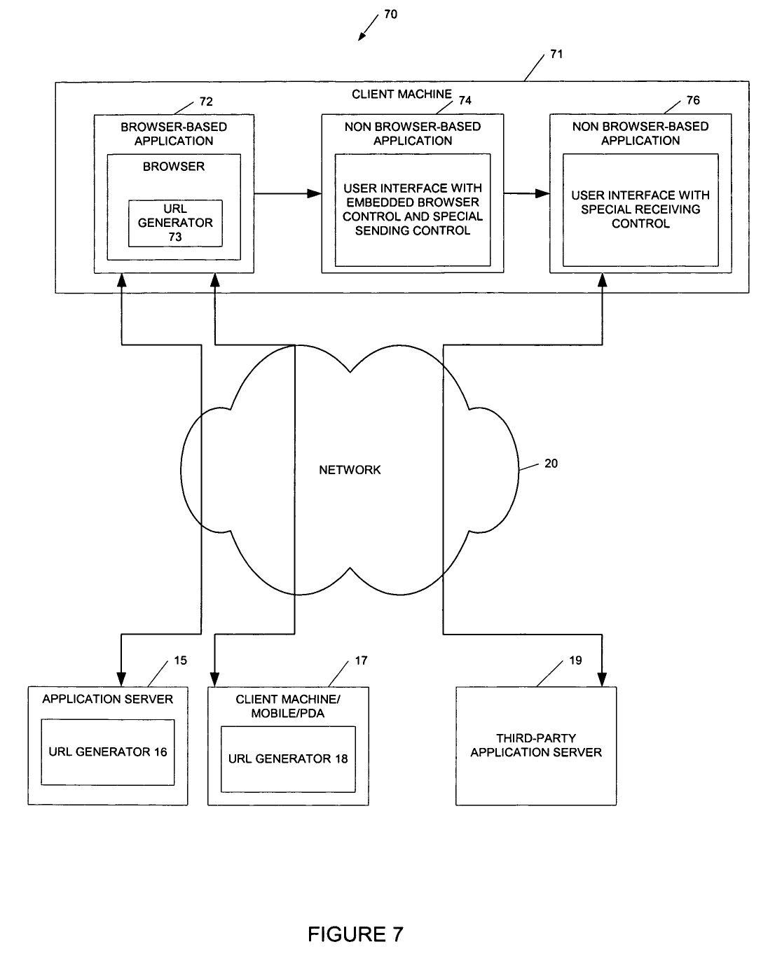

FIG. 7 is a block diagram illustrating the network environment 70 in which an alternative embodiment of the present invention may be implemented. In this embodiment, FIG. 7 includes the network components as illustrated in FIG. 5 and a second non browser-based application 76 residing on the first client machine 71.

According to an exemplary embodiment of the present invention, the first non browser-based application 74 includes a browser control which opens a display window. In addition, the first non browser-based application 74 contains the necessary interface and protocol to communicate with the second non browser-based application 76. The first non browser-based application 74 supports a sending control and the second non browser-based application 76 supports a receiving control. The controls enable communication between the applications 74 and 76.

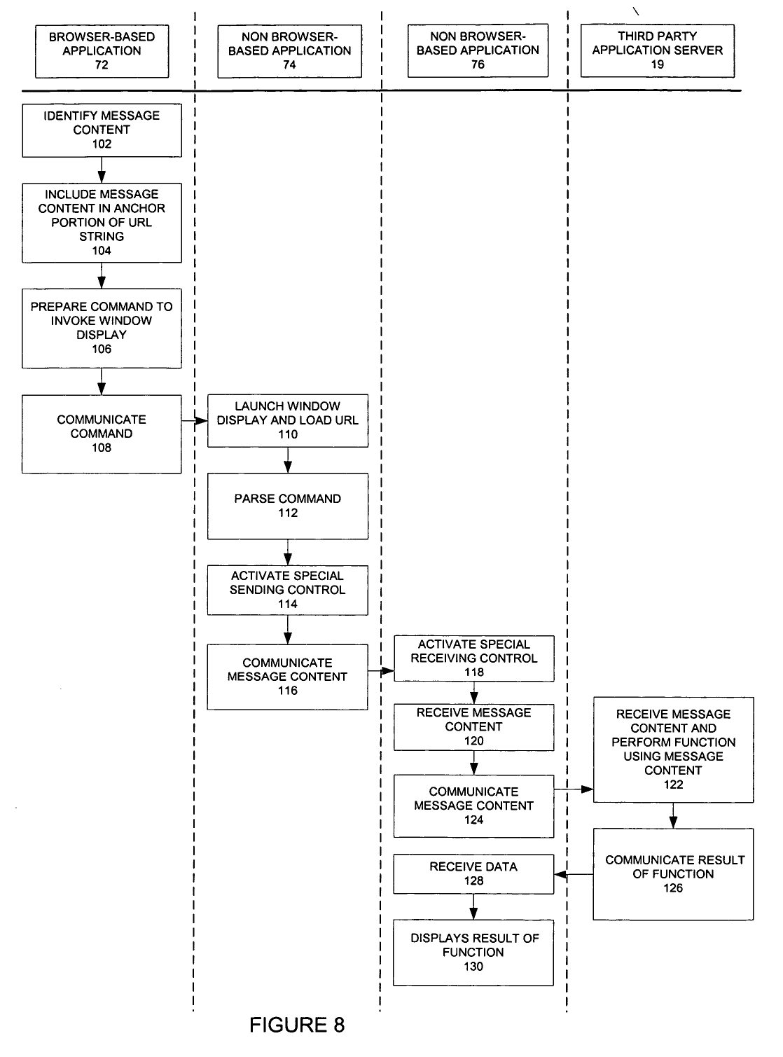

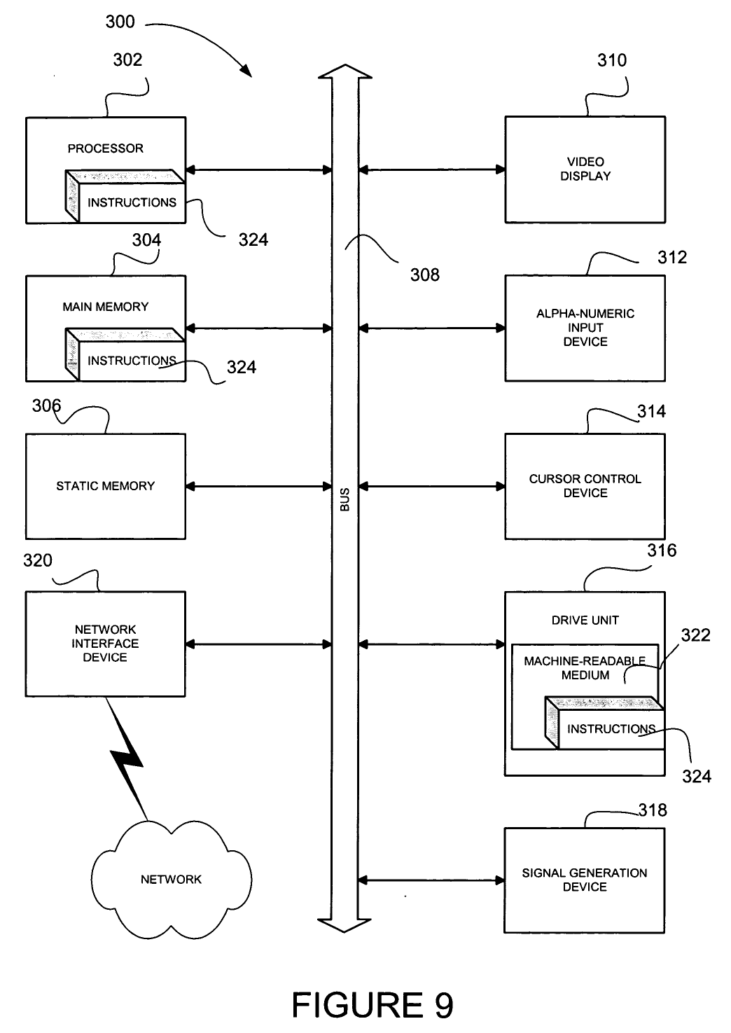

FIG. 8 is an interaction flow chart illustrating a method, according to another exemplary embodiment of the present invention, to communicate message content between the browser-based application 72 and the second non browser-based application 76, using a first non browser-based application 74 with embedded browser control and sending control to bridge the communication.

Starting at block 102, the browser-based application 72 identifies a message content which, in one exemplary embodiment, requires the third party application server 19 to perform some functions. At block 104, the browser-based application 72 includes the message content in an anchor portion 62 of a URL string that is addressed to the third party application server 19 to be executed within the second non browser-based application 76. An example of a URL string that may be generated at block 104 is: “http://www.server19.com/receiver.html#message”.

In this exemplary URL, the data that is included in the anchor portion 62 is the text “message”. The above exemplary URL string is also addressed to the third party application server 19, and also calls a HTML document, namely “receiver.html”.

At block 106, the browser-based application 72 prepares the command to invoke the embedded browser control of the first non browser-based application 74. An example of such a command is: “window.open(“http://www.server19.com/receiver.html#message”, “name of embedded browser”).

The command is communicated to the first non browser-based application 74 at block 108, which invokes the embedded browser control and launches a display window with the specified URL at block 110. At block 112, the first non browser-based application 74 parses the received URL string to extract the message content contained in the anchor portion 62 thereof.

Whereafter, at block 114, the first non browser-based application 74 activates sending control. The sending control enables the first non browser-based application 74 to send the message content to the second non browser-based application 76 at block 108.

Similarly, the second browser-based application 76 activates the receiving control at block 118, enabling the application to receive the message content at step 120. At block 124, the second browser-based application 76 communicates the message content to the third party application server 19.

The third party application server 19 receives the message content at block 122, and may optionally perform one or more functions utilizing this data. The result of the function is returned to the second non-browser based application 76 at block 126.

At block 128, the second non browser-based application 76 receives the result. Thereafter, the result is displayed in the user interface of the second non browser-based application 76 at block 130.

The above-described exemplary embodiments of the present invention may find application in communicating data, or messages, between browser-based applications in a multitude of scenarios. For example, where a browser-based application includes Java script on the client side that receives the ticker symbols and stock price information, the above-described embodiments of the present invention could be utilized to communicate the stock price information to a non browser-based application that may take action based on a stock price. For example, the non browser-based application may issue warnings when a stock price exhibits a predetermined degree of movement, or could even initiate automated buy and sell operations.

In a further use scenario, a browser-based application may be an inventory control application that communicates inventory information to a non browser-based application that is tasked with replenishing inventory levels should these fall below a predetermined level.

In a third use scenario, the browser-based application may be a customer service application that communicates data to a non browser-based problem recovery application.

It should also be noted that, while the above-described embodiments have focused on the communication of data from a browser-based application to a non browser-based application, the present invention could readily be deployed to provide both applications with the capability to both receive and transmit messages and data.

FIG. 10 shows a diagrammatic representation of a machine in the exemplary form of a computer system 300 within which a set of instructions for causing the machine to perform any one or more of the methodologies discussed herein may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The exemplary computer system 300 includes a processor 302 (e.g., a central processing unit (CPU) a graphics processing unit (GPU) or both), a main memory 304 and a static memory 306, which communicate with each other via a bus 308. The computer system 300 may further include a video display unit 310 (e.g., a liquid crystal display (LCD) or a cathode ray tube (CRT)). The computer system 300 also includes an alphanumeric input device 312 (e.g., a keyboard), a user interface (UI) navigation device 314 (e.g., a mouse), a disk drive unit 316, a signal generation device 318 (e.g., a speaker) and a network interface device 320.

The disk drive unit 316 includes a machine-readable medium 322 on which is stored one or more sets of instructions (e.g., software 324) embodying any one or more of the methodologies or functions described herein. The software 324 may also reside, completely or at least partially, within the main memory 304 and/or within the processor 302 during execution thereof by the computer system 300, the main memory 304 and the processor 302 also constituting machine-readable media.

The software 324 may further be transmitted or received over a network 326 via the network interface device 320.

While the machine-readable medium 392 is shown in an exemplary embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention. The term “machine-readable medium” shall accordingly be taken to included, but not be limited to, solid-state memories, optical.and magnetic media, and carrier wave signals.

Thus, a method and system to communicate data between a browser-based application and a non browser-based application have been described. Although the present invention has been described with reference to specific exemplary embodiments, it will be evident that various modifications and changes may be made to these embodiments without departing from the broader spirit and scope of the invention. Accordingly, the specification and drawings are to be regarded in an illustrative rather than a restrictive sense.

What is claimed is:

1. A method to communicate data between a first application client and a second application client, the method including:
at the first application client, embedding data in an anchor portion of a URL string that identifies a message content;
at the first application client, invoking execution of an embedded browser component of the second application client by communicating the URL string to the second application client; and
at the second application client, parsing the URL string and extracting the data therefrom,
wherein the parsing of the URL string at the second application client causes the second application client to perform a function using the data.

2. The method of claim 1, wherein the first application client is browser-based and the second application client is non-browser based.

3. The method of claim 2, wherein both the first application client and the second application client reside on a common machine.

4. The method of claim 1, further including, embedding the browser component in the second application.

5. The method of claim 4, wherein the embedding of the browser component includes providing a browser window control.

6. The method of claim 1, wherein the performing of the function using the data includes accessing a server associated with the URL string.

7. The method of claim 6, further including, at the second application client, receiving a result of the function from the server.

8. The method of claim 7, further including, at the second application client, displaying the result of the function.

9. The method of claim 7, further including, at the second application client, returning the result of the function to the first application client.

10. The method of claim 9, further including, at the first application client, displaying the result of the function in a browser window.

11. The method of claim 1, wherein the performing of the function using the data includes providing a third application client with the data.

12. The method of claim 11, wherein the third application client is non-browser based.

13. The method of claim 12, wherein the second application client includes a sending control and third application client includes a receiving control, the sending control and the receiving control determining a communication protocol between the second application client and the third application client.

14. The method of claim 13, wherein the first application client, the second application client and the third application client reside on a common machine.

15. The method of claim 11, further including, at the third application client, performing a further function using the data.

16. The method of claim 15, wherein the performing of the further function using the data includes accessing a server associated with the URL string.

17. The method of claim 16, further including, at the third application client, receiving a result of the further function from the server and providing the result of the function to the second application client.

18. The method of claim 17, further including, at the second application client, displaying the result of the function.

19. The method of claim 16, further including, at the third application client, receiving a result of the function from the server and displaying the result of the function.

20. A system to communicate data between a first application client and a second application client, the system including:
the first application client to embed data in an anchor portion of a URL string that identifies a message content and to communicate the URL string to a second application client to invoke execution of an embedded browser component of a second application client; and
the second application client to parse the URL string, extract the data therefrom and to perform a function using the data.

21. The system of claim 20, wherein the first application client is browser-based and the second application client is non-browser based.

22. The system of claim 21, wherein both the first application client and the second application client reside on a common machine.

23. The system of claim 20, wherein the second application client is to perform the function using the data by accessing a server associated with the URL string.

24. The system of claim 23, wherein the second application client is to receive a result of the function from the server.

25. The system of claim 24, wherein the second application client is to display the result of the function.

26. The system of claim 24, wherein the second application client is to return the result of the function to the first application client.

27. The system of claim 26, wherein the first application client is to display the result of the function in a browser window.

28. The system of claim 20, wherein the second application client is toperform the function using the data by providing a third application client with the data.

29. The system of claim 28, wherein the third application client is non-browser based.

30. The system of claim 29, wherein the second application client includes a sending control and third application client includes a receiving control, the sending control and the receiving control determining a communication protocol between the second application client and the third application client.

31. The system of claim 30, wherein the first application client, the second application client and the third application client reside on a common machine.

32. The system of claim 28, wherein the third application client is to perform a further function using the data.

33. The system of claim 32, wherein the third application client is to perform the further function using the data by accessing a server associated with the URL string.

34. The system of claim 33, wherein the third application client is to receive a result of the further function from the server and to provide the result of the function to the second application client.

35. The system of claim 34, wherein the second application client is to display the result of the function.

36. The system of claim 33, wherein the third application plant is to receive a result of the function from the server and to display the result of the function.

37. A machine-readable medium storing a set of instructions that, when executed by machine, cause the machine to facilitate communication of data between a browser-based application and a first non browser-based application utilizing a method, the method including:
at the browser-based application, embedding a data in an anchor portion of a URL strings that identifies a message content;
at the browser-based application, invoking execution of an embedded browser component of the first non browser-based application by communicating the URL string to the first non browser-based application; and
at the first non browser-based application, parsing the URL string and extracting the data therefrom,
wherein the parsing of the URL string at the first non browser-based application causes the first non browser-based application to perform a function using the data.

38. The machine-readable medium of claim 37, wherein the browser-based application and the first non browser-based application reside on a common machine.

39. A system to communicate data between a first application client and a second application client, the system including:
first means for embedding data in an anchor portion of a URL string that identifies a message content and for communicating the URL string to a second application client to invoke execution of an embedded browser component of a second application client; and
second means for parsing the URL string, extracting the data therefrom and performing a function using the data.
